(19) United States
(12) Patent Application Publication
(10) Pub. No.: US 2015/0029744 A1
(43) Pub. Date: Jan. 29, 2015

(54) ROTATED MICRO-OPTICAL STRUCTURES FOR BANDING SUPPRESSION FROM POINT LIGHT SOURCES

(71) Applicants: Daniel K. Van Ostrand, The Woodlands, TX (US); Ying Zhou, The Woodlands, TX (US); Martin A. Kykta, The Woodlands, TX (US)

(72) Inventors: Daniel K. Van Ostrand, The Woodlands, TX (US); Ying Zhou, The Woodlands, TX (US); Martin A. Kykta, The Woodlands, TX (US)

(73) Assignee: UNIPIXEL DISPLAYS, INC., The Woodlands, TX (US)

(21) Appl. No.: 13/818,903

(22) PCT Filed: Aug. 24, 2011
(86) PCT No.: PCT/US2011/048911

§ 371 Date: May 8, 2013

Related U.S. Application Data
(60) Provisional application No. 61/376,587, filed on Aug. 24, 2010.

(51) Int. Cl. F21V 8/00

(52) U.S. Cl. CPC G02B 6/0038
USPC 362/606; 362/346

(57) ABSTRACT

An apparatus for use on an edge-injected, total internal reflection (TIR) waveguide. The apparatus comprises a substrate and a plurality of microstructures provided on the substrate. Each microstructure comprises at least two approximately planar surfaces for extracting light from the TIR waveguide. The plurality of microstructures are pseudo-randomly oriented on the substrate. The apparatus may used in a lighting system (e.g., a backlight for a display).

### BACKGROUND

Generally in edge-lit display backlights, light from the source (cold cathode fluorescent lamp, or LEDs) is coupled into the waveguide (also called a light guide) and then extracted out of the waveguide through frustrated total internal reflection (TIR). Light extraction features may include raised or depressed structures such as dots, V-grooves, or other micro optical structures. When designed as a reflecting surface to direct the light out of the waveguide toward the viewer, the side face of the micro optical structures, in many cases, creates a “mirror” or reflection effect by which the individual light source (i.e., individual LED) is imaged to the viewer. This may cause the undesired optical artifact of color banding, in the case of tri-color LEDs (red, blue, green) used in color sequential displays, or bright white banding in the case of white LEDs.

In some edge lit, planar light emitting applications (e.g., LCD backlights, TMOS™ displays, general lighting panels) the color banding artifact unfortunately can be quite pronounced depending on the shape of the micro-optical structures used to extract light.

### BRIEF DESCRIPTION OF THE DRAWINGS

For a detailed description of exemplary embodiments of the invention, reference will now be made to the accompanying drawings in which:

FIG. 1 shows a perspective view of waveguide with side light usable in a display system in accordance with various embodiments;

FIG. 2 shows a perspective view of microstructures on a surface of the waveguide of FIG. 1 in accordance with various embodiments;

FIGS. 3A and 3B illustrate the operation of the waveguide of FIG. 1 in accordance with various embodiments;

FIG. 4 illustrates a banding problem characteristic of at least some display systems;

FIG. 5 shows one preferred microstructure usable in the waveguide;

FIG. 6 shows another preferred microstructure usable in the waveguide;

FIGS. 7 and 8 illustrate a preferred embodiment of waveguide microstructures which are oriented in a pseudo-random fashion on the waveguide to reduce or eliminate the banding problem of FIG. 4.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

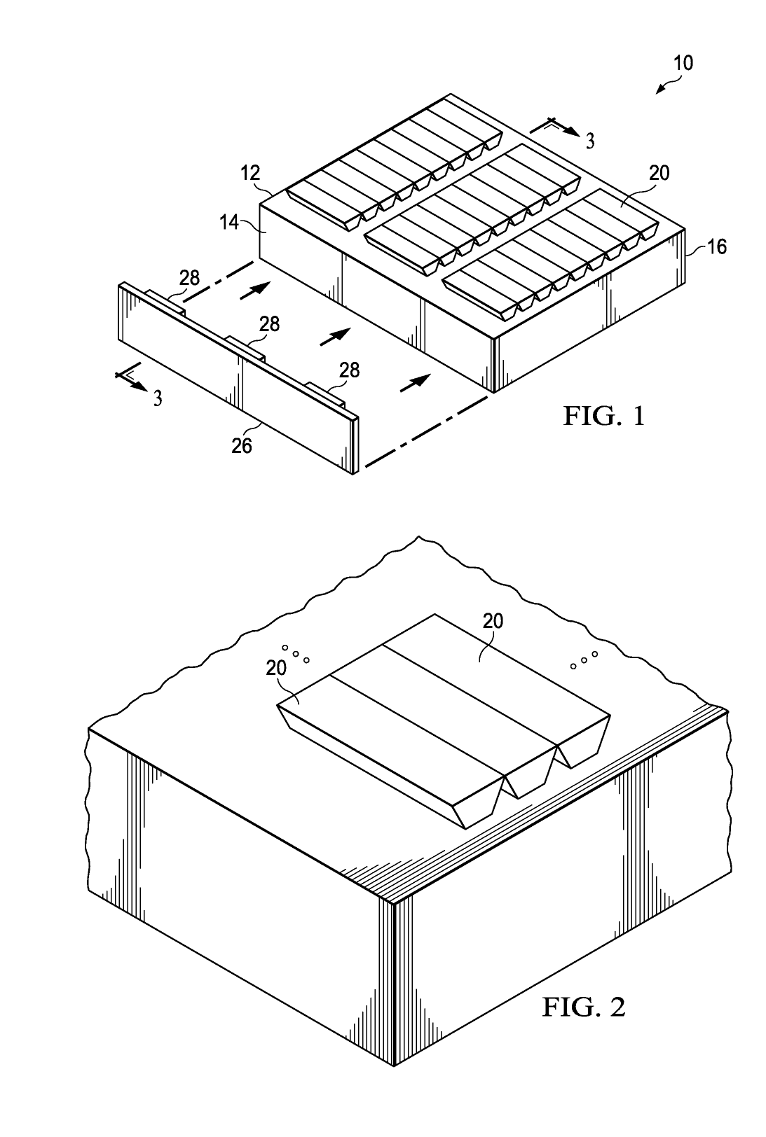

FIG. 1 depicts a waveguide 12 to which a light panel 26 can be placed next to. The waveguide 12 is generally transparent and made from glass, plastic, or other suitable material. The light panel 26 comprises one or more light sources 28 such as light emitting diodes (LEDs), cold cathode fluorescent lamps (CCFLs), or other types of light sources. With the light panel 26 placed next to the waveguide 12, each light source 28 injects light into the waveguide 12 from the side. The waveguide 12 is thus edge-lit.

The waveguide 12 generally causes a total internal reflection (TIR) phenomenon in which the light rays from the light sources 28 reflect off the internal surfaces of the waveguide. Microstructures 20 are included as part of an apparatus for use with the waveguide 12. The apparatus includes a substrate into which the microstructures are formed or to which the microstructures 20 are adhered. The substrate of the apparatus may comprise an outer surface of the waveguide itself 12 or the substrate may be provided in the form of a film. If the substrate of the apparatus is an outer surface of the waveguide itself, the microstructures are patterned directly on the waveguide. However, as a film, the microstructures 20 are formed as part of the film and the film is then adhered to the waveguide 12. Suitable films may comprise adhesive films having a layer of adhesive. Alternatively, the film may be mated to the substrated through van der waals forces (i.e. very smooth and flat surfaces), optical bonding interlayers, pressure (e.g., physical force, atmospheric differential or vacuum, electrostatic force, magnetic force, etc.), melting (heat, sonic or chemical), and the like.

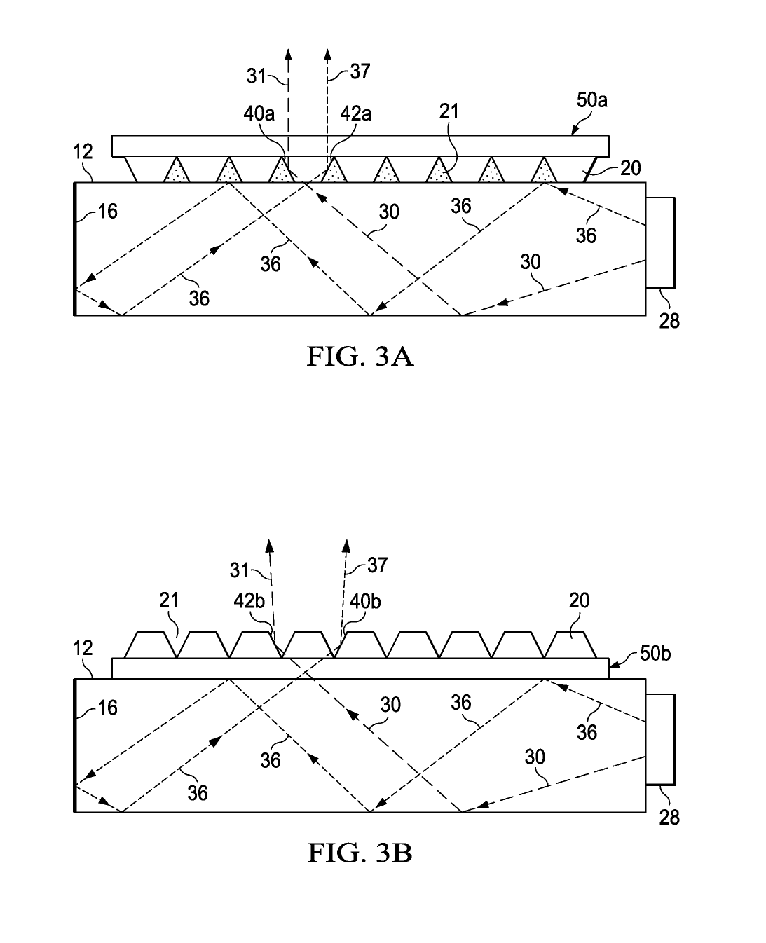

Each microstructure 20 causes light from within the waveguide and originating from the light sources 28 to reflect out of the waveguide 12 in a direction nearly normal (perpendicular) to the plane of the waveguide's largest surface. As such, each microstructure 20 extracts light from the waveguide 12. The extracted light can then be used, for example, to illuminate a display such as a liquid crystal display (LCD) panel. In general, the waveguide 12 can be used as part of any type of lighting system. FIGS. 3A and 3B will be used to explain the optics of the waveguide 12 and microstructures 20 in greater detail. The waveguide 12 has a rear surface 16 opposite the light injection surface 14. In some embodiments, rear surface 16 comprises or is mated to a mirrored surface. The rear surface 16 instead may be uncoated.

FIG. 2 shows close-up detail of several of the microstructures 20. In the embodiment of FIG. 2, each microstructure 20 comprises a trapezoidal frustum (or truncated prism) and thus the cross-sectional shape is a trapezoid. In the embodiment of FIGS. 1 and 2, the microstructures 20 are generally arranged in a uniformly oriented fashion.

FIGS. 3A and 3B illustrate schematic side views of the waveguide 12. The waveguide 12 may be made of plastic, glass, or other suitable material. The microstructures 20 are provided as part of a film 50a (FIG. 3A) and film 50b (FIG. 3B) which is adhered to the top surface of the waveguide. The triangular regions 21 between microstructures 20 comprise air. The film 50a,b comprises a substrate to which multiple microstructures 20 are coupled to or in which such microstructures are formed. In some embodiments, the film has microstructures that are recessed into the film and positioned adjacent the waveguide 12 (as in the example of FIG. 3A), while in other embodiments, the microstructures are raised from the film and positioned on the side of the film opposite the waveguide (as in the example of FIG. 3B). As shown in FIG. 3A, the film 50a is structured such that, when in place on the waveguide, the microstructures 20 are positioned with their wider surface towards the waveguide, whereas in FIG. 3B, the film 50b is structured such that, when in place on the waveguide, the microstructures 20 are positioned with their narrower surface towards the waveguide.

The film 50a,b may be positioned on the top, bottom or both sides of the waveguide. A single light source 28 is shown to the right and injects light into the waveguide. The direction of travel of two light waves is shown with reference numerals 30 and 36 in FIGS. 3A and 3B. Light wave 30 reflects off the bottom surface of the waveguide and then proceeds to contact one of the microstructures 20 which causes the light to be extracted from the waveguide. In this cross sectional view, each microstructure 20 comprises two angled side surfaces 40a and 42a as shown in FIG. 3A and side surfaces 40b and 42b as shown in FIG. 3B. Light wave 30 contacts the distal side surface 40a/42b (distal with respect to the light source 28) of a microstructure 20. The angle of the side surface 40a/42b is set so that the light 31 that reflects off that surface exits the film 50a,b in a direction that is generally perpendicular to the plane of the waveguide 12.

As shown in FIGS. 3A and 3B, light wave 36 reflects off of the bottom surface of the waveguide 12 and then contacts the top surface but not at a location occupied by a microstructure 20. The TIR nature of the waveguide 12 causes the light to reflect off the bottom and top surfaces until it contacts the rear surface 16 which is a mirrored surface thereby causing the light to reflect off that surface as well. The light 36 then begins traversing back through the waveguide until it contacts a microstructure 20 as shown. The light wave 36 contacts the proximal side surface 42a/40b of the microstructure 20 which reflects the light (light 37) at a direction generally perpendicular to the plane of the waveguide 12. In this way, the microstructures 20 cause the light to be extracted from the waveguide. Not all of the extracted light is necessarily extracted from the same waveguide surface. For example, depending on the shape of the microstructures and angle of a particular light ray, such a light may be reflected off of a surface 40b from the light source 28 and then traverse back through the waveguide and out the side opposite where the microstructures are located.

Each of the microstructures in the various embodiments discussed herein comprises at least two approximately planar surfaces which reflect and refract light out of the waveguide 12. In some embodiments, approximately planar means that the sidewall of the microstructure is flat or planar, like the surfaces of the waveguide. Given the available fabrication techniques for making these microstructures, it may not be possible to make these surfaces precisely planar. The corners of the microstructure may be rounded, the average roughness of the surfaces may be non-zero, or the surface may by slightly bowed either in a convex or concave fashion. However, flatter and smoother are the surfaces of the microstructure, the more efficiently they will redirect light out of the waveguide.

The range of angles of light injected into the waveguide 12 combined with the angle of the sidewalls of the numerous closely spaced microstructures 20 cause light to emanate out of the waveguide 12 in a range of angles (including, for example, 90 degrees) from near normal direction to waveguide surface. Such light can be used, for example, to backlight a display such as a liquid crystal display (LCD). Because the lighting system is on the side and not behind the display, the overall thickness of the resulting display system is thinner than with CCFL back-lit displays.

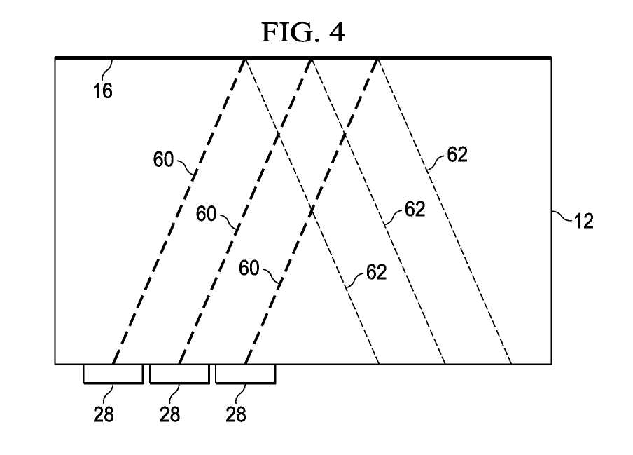

A problem, however, with at least some edge-light display systems which are illuminated with point source lighting (such as LEDs) is “banding” or variations of light intensity. FIG. 4 conceptually illustrates the banding problem. Three light sources 28 are shown adjacent to the waveguide 12. The angled side surfaces 40 and 42 of the microstructures 20 are flat and behave as a mirror (i.e., high degree of specular reflection) in reflecting the light out of the waveguide 12. The microstructures 20 are not shown in FIG. 4, but the microstructures extend sideways (from left to right) on the front surface (not shown in FIG. 4) of the waveguide depicted in FIG. 4, oriented perpendicular to the face of the waveguide where the light sources 28 are located. The microstructures have dimensions generally too small to see with the naked eye. As light from each light source 28 contacts the sidewall of a microstructure 20, the light is reflected upward and out of the waveguide (toward the viewer) as explained above regarding FIG. 3. The microstructures 20 are spaced sufficiently close together that, to a viewer, the entire surface of the waveguide 12 that is covered with the microstructures 20 appears to emit light. However, because the sidewalls of the microstructures 12 are flat and specularly reflective, like a mirror, the net affect is that there appears to be a higher intensity ‘band’ 60 of light on the path between each of the light source 28 and the viewer's eyes, just like looking at the reflection of a light bulb in a mirror. As the light reflects off rear mirrored surface 16, another light band 62 is produced as well. The initial light band 60 is brighter than the reflected light band 62 as depicted by bands 60 rendered with thicker lines than bands 62.

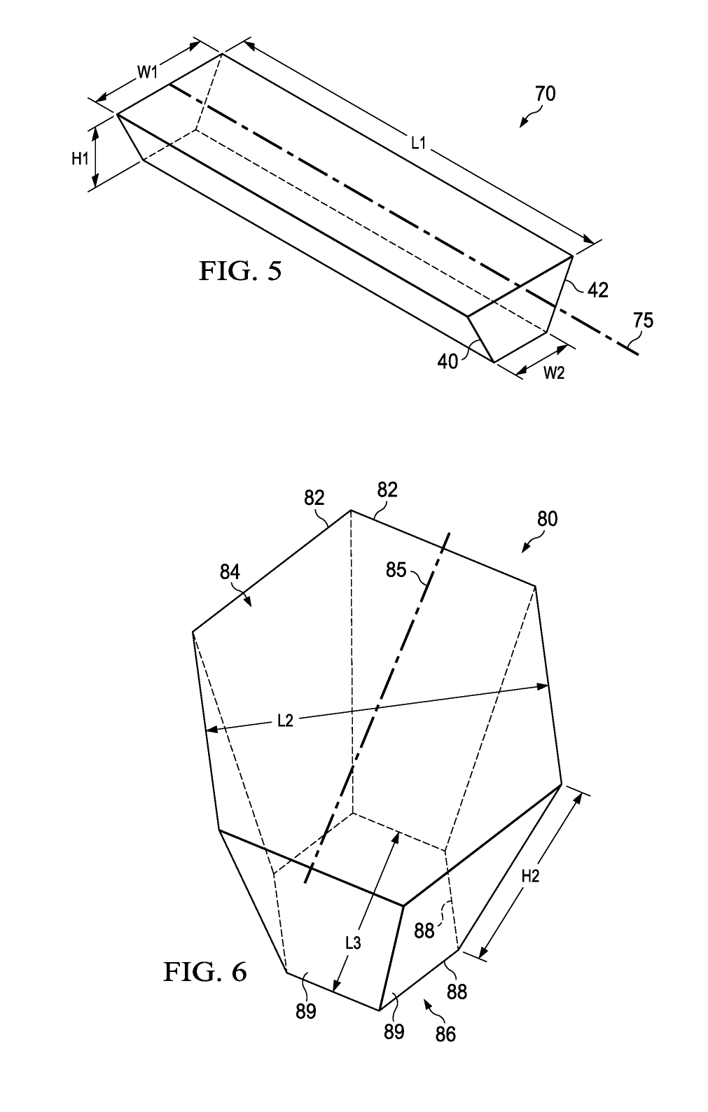

FIGS. 5 and 6 illustrate two examples of microstructures usable in accordance with preferred embodiments. In at least some embodiments, the microstructures are all near homogenous in size and in shape. In FIG. 5, the microstructure 70 is as described previously—a trapezoidal frustum. The length is represented by L1 and the height by H1. The width of the long side of the trapezoidal cross-section is represented as W1 and the width of the trapezoid's short side is W2. The dimensions of L1, H1, W1, and W2 can be customized to suit varying desires and applications. In some embodiments, however, L1 is in the range of 4 to 1000 microns, H1 is in the range of 1.5 to 105 microns, W1 is in the range of 4 to 400 microns, and W2 is in the range of 2 to 150 microns. Axis 75, as shown, extends along the length L1 of the microstructure 70. The short side (W2) is the side that contacts the waveguide 12.

FIG. 6 illustrates a microstructure 80 in the form of a truncated hexagonal frustum (or truncated hexagonal prism). The top surface 84 and bottom surface 86 of microstructure 80 are hexagonal with hexagonal top surface 84 being larger than hexagonal bottom surface 86. The smaller hexagonal bottom surface 86 contacts the waveguide 12. The diameter of the top surface 84 is represented as L2, the diameter of the bottom surface 86 is represented as L3, and the overall height of microstructure 12 is H2. The dimensions of L2, L3, and H2 can be varied as desired. In accordance with at least some embodiments L2 is in the range of 3 to 300 microns, L3 is in the range of 2 to 150 microns, and H2 is in the range of 1.5 to 105 microns. An axis 85 is shown bisecting two oppositely facing edges 82 of the top surface 84 and extending through the center of the top surface 84.

The microstructures may comprise any suitable shape. Examples of suitable shapes include triangular, trapezoidal (FIG. 5), square, pentagonal, hexagonal (FIG. 6), octagonal, or other polygon frustums.

As noted above, each of the microstructures comprise at least two approximately planar reflecting surfaces for extracting light from the waveguide 12. Microstructures 70 (FIG. 5) comprise two such surfaces 40 and 42, while microstructures 80 (FIG. 6) comprise six such surfaces 89.

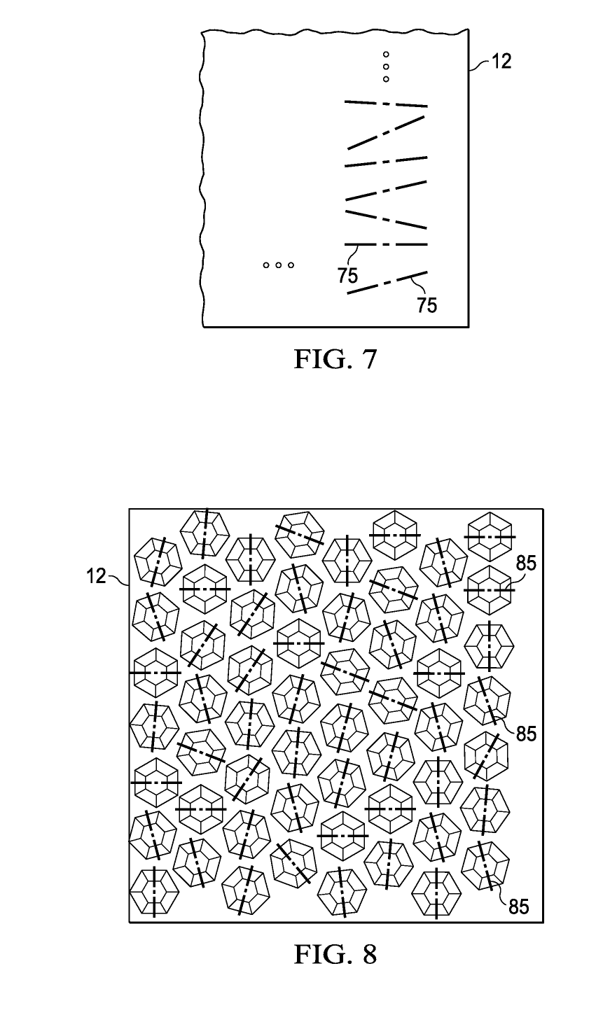

When the microstructures are all of the same orientation, the combined reflection from the micro-optic reflecting surfaces creates the undesired light banding effect noted previously. In accordance with various preferred embodiments, the microstructures provided on the waveguide thus are oriented in random or pseudo-random fashion as illustrated in FIGS. 7 and 8. FIG. 7 illustrates the axes 75 of a number of the microstructures 70 disposed on the waveguide 12. The microstructures 70 themselves are not shown to better illustrate the orientation of the microstructures. In FIG. 8, the orientation of the hexagonally-shaped microstructures 80 is configured as illustrated by the pseudo random orientation of the axes 85.

The angle between adjacent sides of a hexagon is 60°. When making rotated hexagonally-shaped microstructures, the random rotation only needs to vary over a range of 60°; beyond that is simply repeating what has already been done. Each hex-microstructure (or group of microstructures) would have a change in orientation, with respect to the adjacent hex-microstructure, that would vary between 1-59° in some embodiments. The angle between adjacent sides of a rectangle is 90°. Therefore, when making rotated rectangular microstructures in some embodiments, the randomized rotation would be between 1-89° variation between adjacent rectangular microstructures or neighboring groups of rectangular microstructures. Sufficient randomization or pseudo-randomization is obtained when the number of microstructures at each orientation is nearly (e.g., within 10%) the same and there is a near uniform distribution of microstructures at each orientation. The number of different angular orientations may vary depending on the number of sidewalls of the microstructures used and the number and location of light sources.

As noted above, neighboring microstructures may be oriented at angles to each other, the angle varying randomly between adjacent microstructures. Further, groups of microstructures may be provided with each group having commonly oriented microstructure, but neighboring groups of microstructures being angled randomly with respect to each other.

The random nature of the orientation of the light extracting microstructures causes different side faces of various microstructures to receive and reflect the light. Accordingly, light is reflected into different angular directions thereby suppressing or eliminating the banding problem noted above.

In accordance with some embodiments, the microstructures 20, 70, and 80 can be fabricated on an embossing mater using a diamond turning or other suitable process. This embossing master can be used by a traditional hot embossing or UV curable embossing process to transfer the microstructure pattern to a thin polymer film, such as PolyUrethane (hot embossing) or PET (UV curable). Each microstructure preferably has at least two sides. Although trapezoidal prisms and truncated hexagonal prisms are shown in FIGS. 5 and 6, other shapes can be used as well.

As noted above, by pseudo-randomly varying the orientation of the microstructures on the waveguide, banding is reduced. In other embodiments, microstructures with curved surfaces (e.g., truncated cones or conical frustums) can be used and such structures generally result in little if any banding. However, the pseudo-randomly oriented light extracting microstructures with straight (non-curved) sides and edges generally results in light from the waveguide that has higher luminance (i.e., is brighter) than light resulted from a waveguide in which curved microstructures are used due to fact that there generally are multiple bounces within the microstructure itself required to extract most of the light from the waveguide when using curved sided microstructures. The lower light extraction efficiency is primarily due to the losses from multiple bounces (absorption, scattering, reflection and refraction from each bounce) off the curved surfaces of the structure.

What is claimed is:

1. An apparatus for use on an edge-injected total internal reflection (TIR) waveguide, comprising:
a substrate; and
a plurality of microstructures provided on the substrate, each microstructure comprising at least two approximately planar surfaces which are positioned to extract light from the TIR waveguide;
wherein the plurality of microstructures are pseudo-randomly oriented on the substrate.

2. The apparatus of claim 1 in which the microstructures comprise a shape selected from triangular, trapezoidal, square, pentagonal, hexagonal, octagonal, or other polygon frustums.

3. The apparatus of claim 1 wherein the microstructures are raised from substrate.

4. The apparatus of claim 1 wherein the microstructures are recessed into the substrate.

5. The apparatus of claim 1 wherein the substrate is part of a film.

6. The apparatus of claim 1 of claim 1 wherein the substrate comprises an outer surface of the waveguide.

7. The apparatus of claim 1 wherein each microstructure comprises a shape selected from the group consisting of a truncated hexagonal frustum, a truncated hexagonal prism, rectangular, pentagonal, octagonal, and triangular.

8. The apparatus of claim 1 wherein adjacent microstructures are oriented at an angle to each other, said angle varying between 1 and 59 degrees.

9. The apparatus of claim 1 wherein groups of microstructures are oriented at an angle to each other, said angle varying between 1 and 59 degrees.

10. The apparatus of claim 1 wherein adjacent microstructures are oriented at an angle to each other, said angle varying between 1 and 89 degrees.

11. The apparatus of claim 1 wherein groups of microstructures are oriented at an angle to each other, said angle varying between 1 and 89 degrees.

12. The apparatus of claim 1 wherein each microstructure is hexagonal and adjacent microstructures are oriented at an angle to each other, said angle varying between 1 and 59 degrees.

13. The apparatus of claim 1 wherein each microstructure has a surface that is rectangular and adjacent microstructures are oriented at an angle to each other, said angle varying between 1 and 89 degrees.

14. The apparatus of claim 1 wherein the plurality of microstructures are pseudo- randomly oriented on the substrate such that a number of microstructures at each orientation is nearly the same.

15. A system, comprising:
a waveguide configured to receive edge-injected light; and
a plurality of microstructures disposed on the waveguide in a pseudo-random orientation, each microstructure comprising at least two approximately planar surfaces which are positioned to extract light from the waveguide.

16. The system of claim 15 in which the microstructures comprise a shape selected from triangular, trapezoidal, square, pentagonal, hexagonal, octagonal, or other polygon frustums.

17. The system of claim 15 wherein the microstructures are raised from substrate.

18. The system of claim 15 wherein the microstructures are recessed into the substrate.

19. The system of claim 15 wherein the microstructures are disposed on the waveguide as part of a film.

20. The system of claim 15 wherein the substrate comprises an outer surface of the waveguide.

21. The system of claim 15 wherein each microstructure comprises a shape selected from the group consisting of a truncated hexagonal frustum, a truncated hexagonal prism, rectangular, pentagonal, octagonal, and triangular.

22. The system of claim 15 wherein adjacent microstructures are oriented at an angle to each other, said angle varying between 1 and 59 degrees.

23. The system of claim 15 wherein groups of microstructures are oriented at an angle to each other, said angle varying between 1 and 59 degrees.

24. The system of claim 15 wherein adjacent microstructures are oriented at an angle to each other, said angle varying between 1 and 89 degrees.

25. The system of claim 15 wherein groups of microstructures are oriented at an angle to each other, said angle varying between 1 and 89 degrees.

26. The system of claim 15 wherein each microstructure is hexagonal and adjacent microstructures are oriented at an angle to each other, said angle varying between 1 and 59 degrees.

27. The system of claim 15 wherein each microstructure has a surface that is rectangular and adjacent microstructures are oriented at an angle to each other, said angle varying between 1 and 89 degrees.
